(19) United States
(12) Patent Application Publication
(10) Pub. No.: US 2003/0017257 A1
(43) Pub. Date: Jan. 23, 2003

(54) Method for measuring the height of a dispensed material

(76) Inventor: Michael Antoine Birmingham, Ballston Lake, NY (US)

Correspondence Address: Michael A. Birmingham, 12B Sylvan Trail, Ballston Lake, NY, 12019, US

(21) Appl. No.: 10/172,820

(22) Filed: Jun. 15, 2002

Related U.S. Application Data
(60) Provisional application No. 60/299,032, filed on Jun. 18, 2001.

(51) Int. Cl. B05D 1/00

(52) U.S. Cl. 427/10; 427/9

(57) ABSTRACT

An automated system and method for measuring the height of a dispensed material. Depending on the requirements of the application, a pre-dispense scan, following the same path as the dispense cycle, of an object is performed to obtain a reference measurement. An automated dispensing apparatus then dispenses material on the object. A post-dispense scan, following the same path as the dispense cycle, is performed to obtain a height measurement of the dispensed material. Objects which do not meet an acceptable dispensed material height are rejected.

This application claims the benefit of an earlier filed provisional application serial No. 60/299,032 filed on Jun. 18^{th} 2001.

### FIELD OF THE INVENTION

The present invention relates generally to a and method for measuring the height of a dispensed viscous liquid material on a surface. More particularly, the present invention relates to providing a continuous measurement of the dispensed material.

### BACKGROUND OF INVENTION

Automatic liquid dispensing machines are used for dispensing materials, (e.g., mastics, sealants, gaskets, adhesives, conformal coating, solder, etc.) onto a surface of an object. Problems arise when the amount of material is insufficient or excessive. Depending on the application, insufficient or excessive material may render the final product defective. The invention described herein addresses the Quality Assurance aspect of automated material dispensing. In addition, the information obtained by the invention may be analyzed for Statistical Process Control (SPC).

### SUMMARY OF THE INVENTION

The present invention provides an automated method for measuring the height and consistency of a dispensed material. The object may include any suitable object (e.g., valve cover, oil pan, circuit board, etc.) that requires a liquid material (e.g. mastic, sealant, gasket, conformal coating, solder, etc.). The invention may be used for one or more scans (a pre-dispense scan and post-dispense scan or only a post-dispense scan) depending on the requirements of the application. The invention includes a scanning apparatus where the measuring device is typically mounted near the dispense nozzle of a robotic liquid dispensing apparatus. In the event a pre-scan is needed (for accurate material measurements on non-repeatable objects), the robotic apparatus moves the scanning device over a path that is substantially identical to the dispense path for the purpose of obtaining reference measurements. The robotic dispensing apparatus then dispenses the required material on the surface of the object. The scanning device is then moved over a path that is substantially identical to the dispense path to obtain a height measurement of the dispensed material by calculating the difference between the post-dispense measurement and the known height of the object or calculating the difference between the post-dispense measurement and the pre-dispense measurement. The data acquired by the measurement is evaluated against predefined thresholds to determine if the material dispensed is acceptable. The measurement information may be stored and used for Statistical Process Control.

### BRIEF DESCRIPTION OF THE DRAWINGS

The features of the present invention will best be understood from a detailed description of the invention selected for the purposes of illustration and shown in the accompanying drawings in which:

FIG. 1 illustrates a front view of a “Z” axis slide on a Cartesian style robotic apparatus.

FIG. 2 illustrates a side view of “Z” axis slide on a Cartesian style robotic apparatus.

FIG. 3 illustrates a view of the dispensing nozzle of a robotic material dispensing apparatus during a dispense cycle.

FIG. 4 illustrates a view of the scanning apparatus during a scanning cycle.

FIG. 5 illustrates a representative path of a dispense and scanning cycle.

FIG. 6 illustrates a representative block diagram of the invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc. The features of the present invention are illustrated in detail in the accompanying drawings, wherein like reference numerals refer to like elements throughout the drawings. Although the drawings are intended to illustrate the present invention, the drawings are not necessarily drawn to scale.

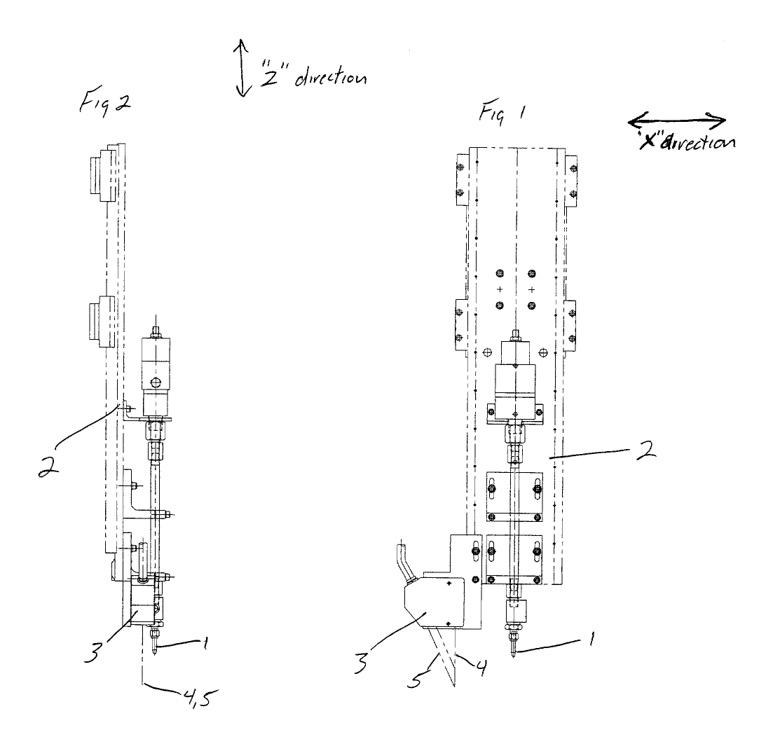

FIG. 1 illustrates a front view of a “Z” axis slide 2, on a Cartesian style robotic motion apparatus. Mounted on the “Z” axis slide 2, are a dispense nozzle 1, and a laser displacement sensor 3. The laser displacement sensor 3, emits a laser beam 4, that is reflected 5, by the object and a displacement is measured.

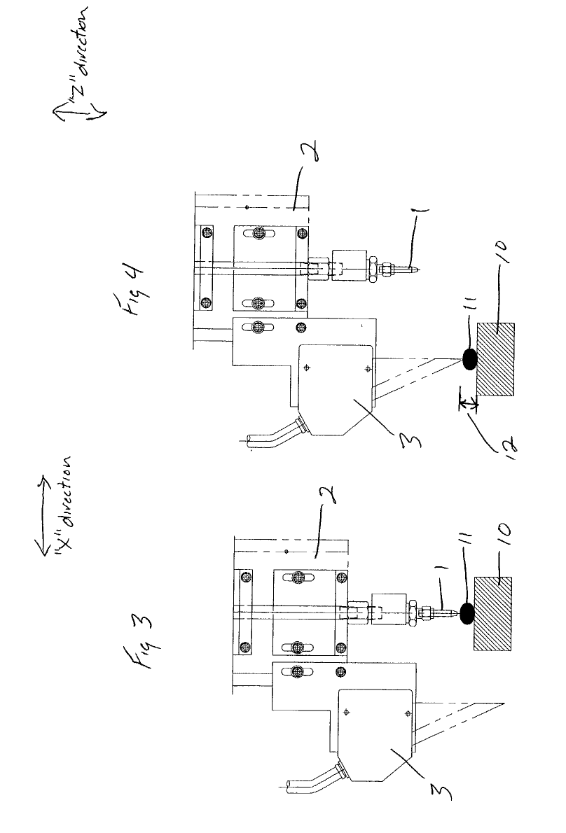

FIG. 2 illustrates a side view of the objects in FIG. 1.

FIG. 3 illustrates a view of the dispense nozzle 1, as it is applying a material 11, to an object 10.

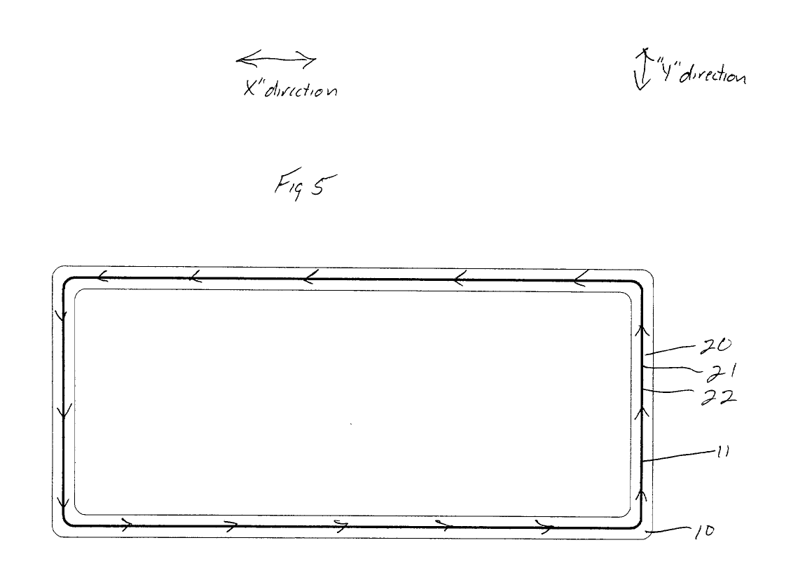

FIG. 4 illustrates a view of the laser displacement sensor 3, during a post-dispense scan 22, measuring the height 12, of the material 11.

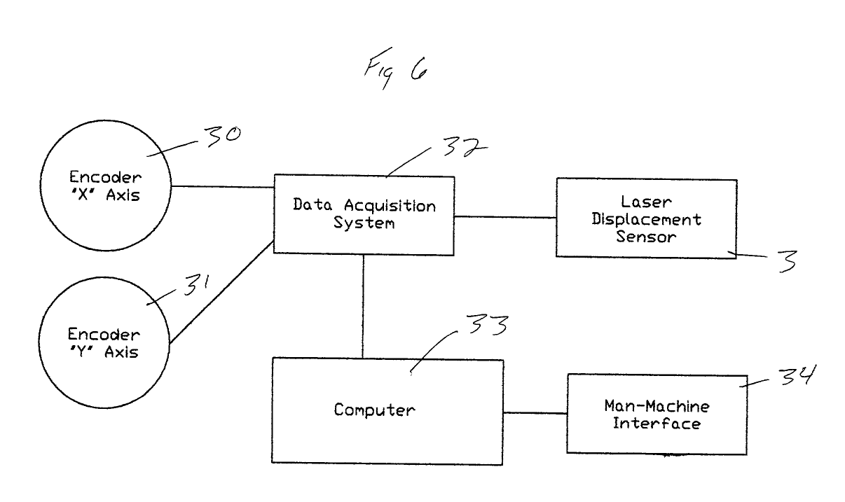

FIG. 5 illustrates a pre-dispense scanning path 20 (if required), a dispense path 21 applying a material 11, to an object 10, and a post-dispense scanning path 22.

FIG. 6 illustrates a representative block diagram of the invention.

It should be noted that for the purposes of this description a Cartesian style robot is used. Optionally, other robotic motion apparatus may be used, such as, an arm robot, an n-axis motion machine (wherein n=2, 3, 4 . . . ), etc.

The robotic dispensing apparatus through either manual or automatic means contains an offset value in the “X”, “Y” and “Z” axis between the tip of the nozzle 1 and the emitted laser beam 4, of the laser displacement sensor 3.

An object 10 is removably fixed into position within the working envelope of a robotic dispensing apparatus. If required, a pre-dispense scan 20, to obtain a reference measurement is performed on the object 10. The laser displacement sensor 3 is moved over the object 10, along the path 20. The path 20 is offset from the dispense path 21 in the “X”, “Y” and “Z” axis by the distance between the nozzle 1, and the emitted laser beam 4. The “X” encoder 30 and “Y” encoder 31 trigger height measurements 12, to be taken along the path 20. (The distance traveled by the scanning apparatus between each measurement can be as fine or coarse as needed by the application. An extremely fine interval can approach for all practical purposes, a continuous measurement.) Additionally the position in the “X” and “Y” directions are acquired by the data acquisition system 32 and recorded by the processing computer 33. The height measurements 12, taken by the data acquisition system 32, is recorded by the processing computer 33. Optionally, other methods could be used for recording position versus height measurement information 12, (e.g. data communication between a robotic controller and the processing computer 33 or data communication between a robotic controller and the acquisition system 32, etc.)

The robotic dispensing apparatus performs a dispense cycle moving the nozzle 1, along the dispense path 21, depositing material 11, on the object 10.

A post-dispense scan 22, is then performed. The laser displacement sensor 3 is moved over the object 10, along the path 22. The path 22 is offset from the dispense path 21 in the “X”, “Y” and “Z” axis by the distance between the nozzle 1, and the emitted laser beam 4. The “X” encoder 30 and “Y” encoder 31 trigger height measurements 12, to be taken along the path 20. Additionally the position in the “X” and “Y” directions are acquired by the data acquisition system 32 and recorded by the processing computer 33. The height measurements 12, taken by the data acquisition system 32, are recorded by the processing computer 33.

The height information 12, measured in the post-dispense scan 22 is calculated by the difference between either with the pre-dispense scan 20 or against stored values in the case of repeatable parts. In the event the height of the material is outside acceptable limits, the processing computer communicates the failure of the dispense operation. The height information 12, may optionally be stored or communicated for later analysis.

In another embodiment of the post-dispense scan. The scan 22 can be performed in a go, no go fashion wherein the height measurement 12 is only evaluated for a low or high delta measurement.

I claim:

1. An method for measuring the height of a dispensed material using a scanning apparatus.

2. The method of claim 1, wherein the measuring method utilizes at least one laser displacement sensor.

3. The method of claim 1, wherein the method further includes a means for inputting parameters, thresholds and/or displaying data.

4. The method of claim 1, wherein the method further includes a method for communicating, calculating and storing data.

5. The method of claim 1, further including a calibration method for determining an offset distance between the displacement sensor and a material dispensing nozzle of the dispensing apparatus.

6. A method comprising:
a. Optionally performing a scan to obtain a reference measurement along the dispensing path;
b. Dispensing a material onto the object along the dispensing path.
c. Performing a scan to obtain a height measurement of the material dispensed.
d. Storing the measurement information for later analysis.

7. The method of claim 6, wherein the material is a viscous material.

8. The method of claim 6, wherein the viscous material is dispensed as a continuous bead.

9. The method of claim 6, wherein the scan is performed using a scanning apparatus.

10. The method of claim 6, further comprising analyzing the scan using a processing computer.

11. The method of claim 6, wherein the scanning path is substantially identical to the dispensing path.
